(19) United States
(12) Patent Application Publication
(10) Pub. No.: US 2025/0139492 A1
(43) Pub. Date: May 1, 2025

(54) Predictive Maintenance for Machine Learning Models to Prevent Model Drift

(71) Applicant: Bank of America Corporation, Charlotte, NC (US)

(72) Inventors: Maharaj Mukherjee, Poughkeepsie, NY (US); Carl Benda, Charlotte, NC (US)

(21) Appl. No.: 18/385,446

(22) Filed: Oct. 31, 2023

(51) Int. Cl. G06N 20/00

(52) U.S. Cl. CPC G06N 20/00

(57) ABSTRACT

A computing platform may train, using historical model performance information, a time to maintenance (TTM) prediction model to output, for a given cluster of machine learning models, a corresponding TTM. The computing platform may obtain model performance information for a plurality of machine learning models. The computing platform may cluster, using model performance information, each of the plurality of machine learning models into one of a plurality of clusters of machine learning models. For each cluster, the computing platform may identify, by inputting information of the corresponding cluster into the TTM prediction model, a TTM. The computing platform may detect, for a first cluster of the plurality of clusters, expiration of a first TTM, corresponding to the first cluster. The computing platform may update, based on detection of the expiration of the first TTM, a first plurality of machine learning models included in the first cluster.

### BACKGROUND

In some instances, machine learning models may be initially trained, but their prediction power may degrade over time due to changes in their environment (which may, e.g., result in changes in relationships between variables of the models themselves). This may be referred to as model drift. Accordingly, it may be important to detect, and subsequently address such model drift to maintain accuracy of the models. In some instances, to do so, models may be periodically retrained in a scheduled manner (e.g., at a predetermined interval) to ensure that the model's accuracy does not fall below a certain threshold. Alternatively, model drift may be addressed through online learning, where information is used to retrain the model as soon as it becomes available in sequential order (e.g., in contrast to training the model with batch information). Implementing these methods, however, may require continuous monitoring of the models, and may consume a significant amount of processing power. Accordingly, it may be important to improve the methods by which model drift is detected and prevented.

### SUMMARY

Aspects of the disclosure provide effective, efficient, scalable, and convenient technical solutions that address and overcome the technical problems associated with the training and application of machine learning models. In accordance with one or more embodiments of the disclosure, a computing platform comprising at least one processor, a communication interface, and memory storing computer-readable instructions may train, using historical model performance information, a time to maintenance (TTM) prediction model, which may configure the TTM prediction model to output, for a given cluster of machine learning models, a corresponding TTM. The computing platform may obtain model performance information for a plurality of machine learning models. The computing platform may cluster, using the model performance information, each of the plurality of machine learning models into one of a plurality of clusters of machine learning models. The computing platform may, for each cluster of the plurality of clusters: 1) identify, by inputting information of the corresponding cluster into the TTM prediction model, a TTM, and 2) store an association between the identified TTM and machine learning models of the corresponding cluster. The computing platform may detect, for a first cluster of the plurality of clusters, expiration of a first TTM, corresponding to the first cluster. The computing platform may update, based on detection of the expiration of the first TTM, a first plurality of machine learning models included in the first cluster.

In one or more instances, the historical model performance information may include one or more of: model application domains, types of information used, number of model dimensions, number of model features, information ranges, information quality, data drift duration, concept drift duration, drift change derivatives, model classifier type, or TTMs. In one or more instances, the computing platform may train, using the historical model performance information, a clustering model, which may configure the clustering model to perform the clustering.

In one or more examples, the clustering model may have a second TTM, longer than the TTMs of the plurality of clusters. In one or more examples, updating a first machine learning model of the first plurality of machine learning models may include updating one or more of: types of information used, number of model dimensions, number of model features, information ranges, information quality, or the first TTM.

In one or more instances, updating the first TTM may include automatically predicting, by the TTM prediction model, an updated TTM for the first cluster, where the prediction of the updated TTM may be based on one or more of: data drift duration, concept drift duration, or drift change derivatives for the first machine learning model. In one or more instances, the computing platform may automatically update, based on detecting that the updated TTM for the first cluster exceeds a TTM of a clustering model, the TTM of the clustering model, where the updated TTM of the clustering model exceeds the updated TTM of the first cluster.

In one or more examples, the computing platform may automatically re-cluster, using the clustering model and based on detecting expiration of the TTM of the clustering model, the plurality of machine learning models. In one or more examples, updating the first plurality of machine learning models may include updating each of the first plurality of machine learning models at substantially the same time.

In one or more examples, updating the first plurality of machine learning models may include updating each of the first plurality of machine learning models prior to detecting, in any of the first plurality of machine learning models, one or more of: information drift that exceeds an information drift threshold or concept drift that exceeds a concept drift threshold.

### BRIEF DESCRIPTION OF DRAWINGS

The present disclosure is illustrated by way of example and is not limited in the accompanying figures in which like reference numerals indicate similar elements and in which:

FIGS. 1A and 1B depict an illustrative computing environment for performing predictive maintenance of machine learning models in accordance with one or more example embodiments.

FIGS. 2A-2D depict an illustrative event sequence for performing predictive maintenance of machine learning models in accordance with one or more example embodiments.

FIGS. 3-4 depict illustrative user interfaces for performing predictive maintenance of machine learning models in accordance with one or more example embodiments.

FIG. 5 depicts an illustrative method for performing predictive maintenance of machine learning models in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

The following description relates to performing predictive maintenance for machine learning models, as is described further below. Model drift refers to the degradation of a model's prediction power due to changes in an environment, and thus the relationships between variables. For example, changes in the presentation of spam emails may cause fraud detection models to degrade.

Concept drift or hypothesis drift is a type of model drift where the properties of the dependent variable changes. For example, in a fraud detection model, an example of concept drift is where the classification of what is fraudulent changes. Data drift is a type of model drift where the properties of the independent variables change. For example, data may change due to seasonality, changes in consumer preferences, the addition of new products, or the like.

One way to detect model drift is by comparing the predicted values from a given machine learning model to the actual values. The accuracy of a model may worsen as the predicted values deviate farther and farther from the actual values. A common metric used to evaluate the accuracy of a model among data is the F1 score, which encompasses both the precision and recall of the model. However, in some instances, other metrics may be used depending on the situation.

Detecting model drift may be a first step—the next step may be addressing the drift. In some instances, the model may be retrained in a scheduled manner. For example, if you know that a model degrades every six months, then you may decide to retrain the model every five months to ensure that the model's accuracy never falls below a certain threshold. Another way to address model drift is through online learning (e.g., making the machine learning model learn in real time). The model may do this by taking in data as soon as it becomes available in sequential order rather than training the model with batch data.

In some instances, however, these methods for addressing model drift may require continuous monitoring of the models. Furthermore, they may be time and resource (e.g., both processing and/or human resources) intensive. For example, these methods may be slow and/or require manual intervention. Additionally, it may be difficult to plan resources needed to recalibrate models for groups responsible for multiple machine learning models.

Accordingly, rather than performing preventative maintenance of machine models, which may require regular monitoring of the model, machine learning based predictive maintenance methods may be used. These methods may use historic data on models to cluster different machine learning models into different groups. Each cluster may be associated with a time to maintenance. Rather than monitoring each model separately, the time to maintenance may be considered as the predicted time for recalibrating the models within that cluster.

These and other features are described in greater detail below.

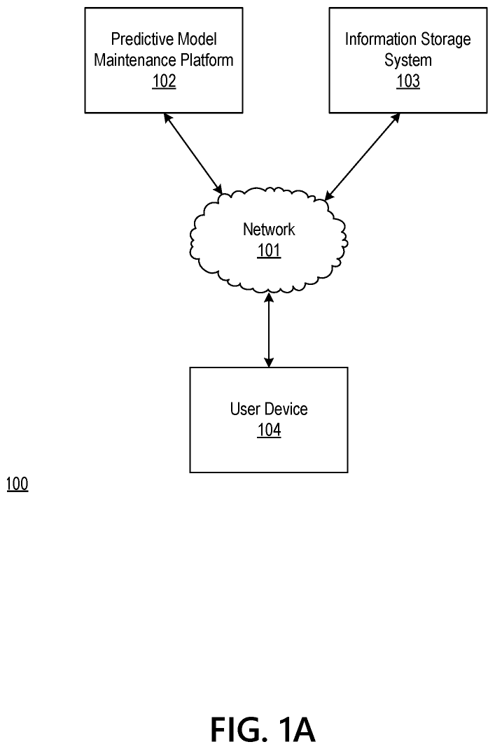

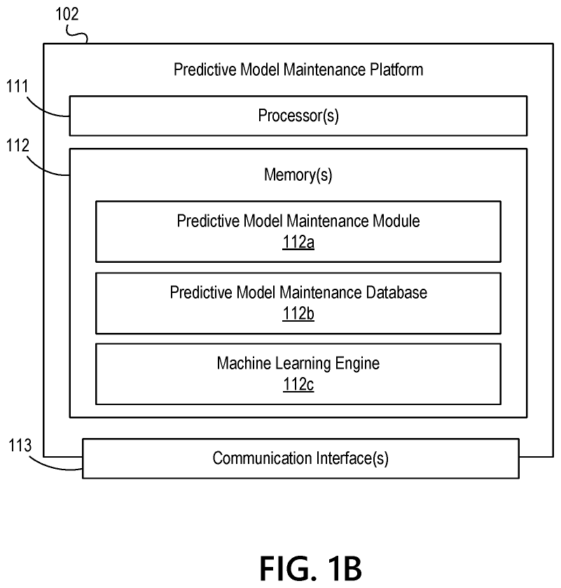

FIGS. 1A-1B depict an illustrative computing environment for using predictive maintenance for machine learning models in accordance with one or more example embodiments. Referring to FIG. 1A, computing environment 100 may include one or more computer systems. For example, computing environment 100 may include predictive model maintenance platform 102, information storage system 103, and user device 104.

Predictive model maintenance platform 102 may include one or more computing devices (servers, server blades, or the like) and/or other computer components (e.g., processors, memories, communication interfaces, or the like). For example, the predictive model maintenance platform 102 may be configured to train, host, and apply a clustering model configured to cluster machine learning models based on their performance characteristics. In some instances, the predictive model maintenance platform 102 may train, host, and apply a machine learning model (e.g., a time to maintenance (TTM) prediction model) to pre-emptively identify TTMs for the identified clusters. In instances where expiration of the TTM is detected for a given cluster, model maintenance may be triggered for all models within that cluster. In some instances, the clustering model and TTM prediction models may be included in a single model, or may be separate models.

Information storage system 103 may include one or more computing devices (servers, server blades, or the like) and/or other computer components (e.g., processors, memories, communication interfaces, or the like). The information storage system 103 may store information, parameters, characteristics, and/or other information that may be used to cluster the machine learning models, and/or generate the corresponding TTMs. In some instances, the information storage system 103 may be configured to communicate with the predictive model maintenance platform 102 to provide this information.

User device 104 may be or include one or more devices (e.g., laptop computers, desktop computer, smartphones, tablets, and/or other devices) configured for use in performing model maintenance. For example, the user device 104 may be operated by an employee of the enterprise organization corresponding to the predictive model maintenance platform 102. In some instances, the user device 104 may be configured to display graphical user interfaces (e.g., model maintenance notifications, or the like). Any number of such user devices may be used to implement the techniques described herein without departing from the scope of the disclosure.

Computing environment 100 also may include one or more networks, which may interconnect predictive model maintenance platform 102, information storage system 103, and user device 104. For example, computing environment 100 may include a network 101 (which may interconnect, e.g., predictive model maintenance platform 102, information storage system 103, and user device 104).

In one or more arrangements, predictive model maintenance platform 102, information storage system 103, and user device 104 may be any type of computing device capable of receiving a user interface, receiving input via the user interface, and communicating the received input to one or more other computing devices, and/or training, hosting, executing, and/or otherwise maintaining one or more machine learning models. For example, predictive model maintenance platform 102, information storage system 103, user device 104, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of predictive model maintenance platform 102, information storage system 103, and user device 104 may, in some instances, be special-purpose computing devices configured to perform specific functions.

Referring to FIG. 1B, predictive model maintenance platform 102 may include one or more processors 111, memory 112, and communication interface 113. A data bus may interconnect processor 111, memory 112, and communication interface 113. Communication interface 113 may be a network interface configured to support communication between predictive model maintenance platform 102 and one or more networks (e.g., network 101, or the like). Memory 112 may include one or more program modules having instructions that when executed by processor 111 cause predictive model maintenance platform 102 to perform one or more functions described herein and/or one or more databases that may store and/or otherwise maintain information which may be used by such program modules and/or processor 111. In some instances, the one or more program modules and/or databases may be stored by and/or maintained in different memory units of predictive model maintenance platform 102 and/or by different computing devices that may form and/or otherwise make up predictive model maintenance platform 102. For example, memory 112 may have, host, store, and/or include predictive model maintenance module 112a, predictive model maintenance database 112b, and machine learning engine 112c. Predictive model maintenance module 112a may have instructions that direct and/or cause predictive model maintenance platform 102 to execute advanced techniques to cluster machine learning models, predict TTMs for the corresponding clusters, and perform model maintenance accordingly. Predictive model maintenance database 112b may store information used by predictive model maintenance module 112a, in performing predictive model maintenance, and/or in performing other functions. Machine learning engine 112c may be used to train, deploy, and/or otherwise refine models (e.g., clustering models, TTM prediction models, and/or other models) used to support functionality of the predictive model maintenance module 112a through both initial training and one or more dynamic feedback loops, which may, e.g., enable continuous improvement of the predictive model maintenance platform 102 and further optimize the predictive model maintenance to prevent model inaccuracies due to data drift.

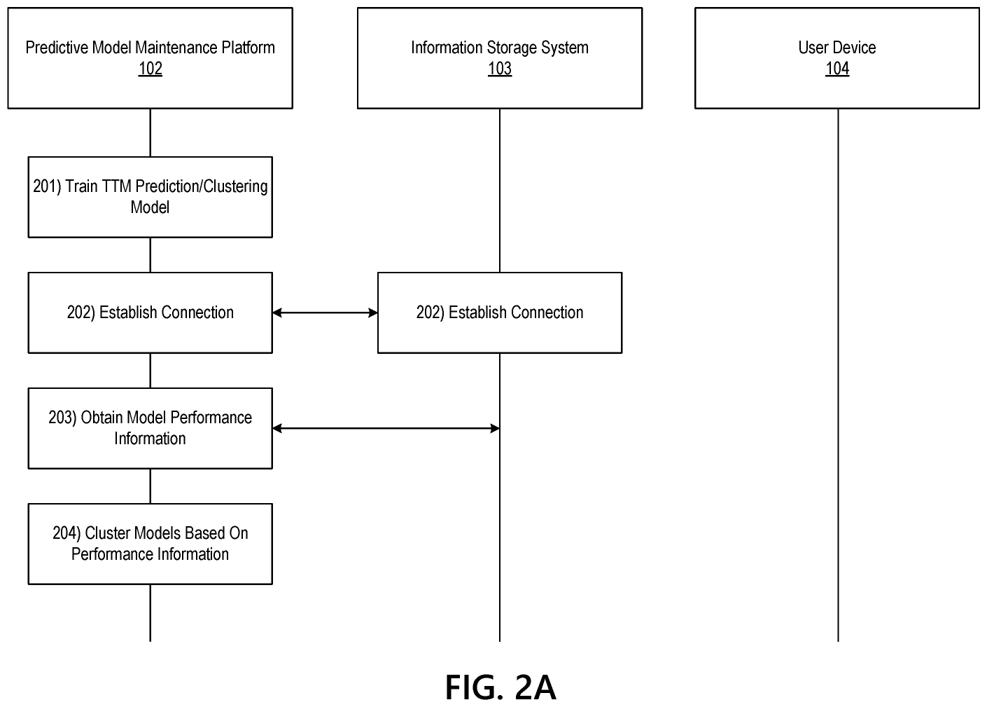

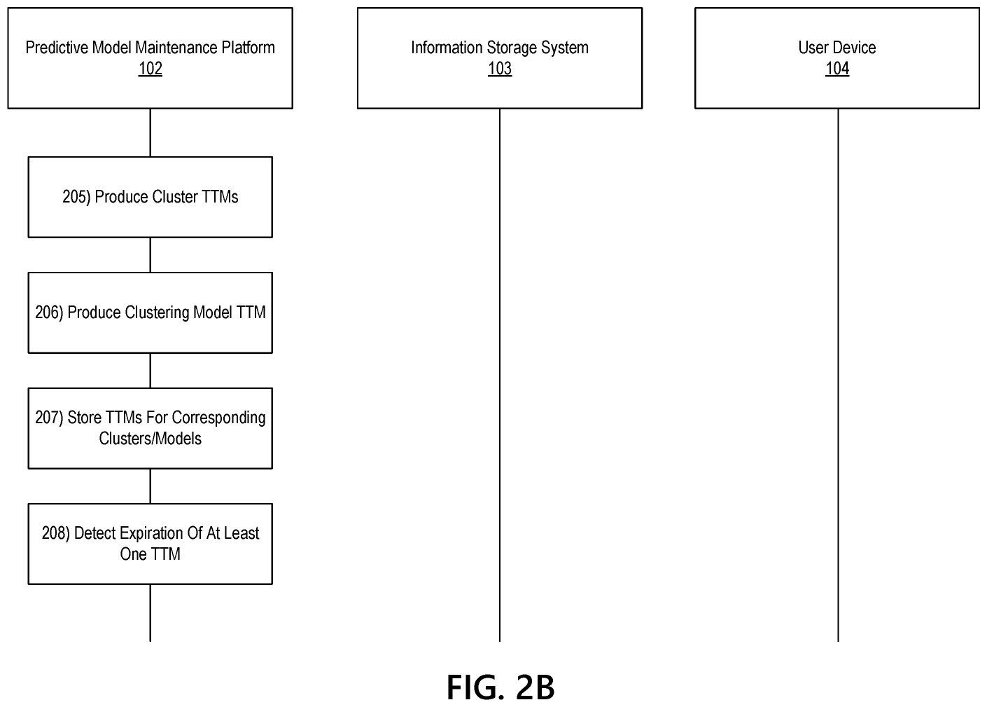

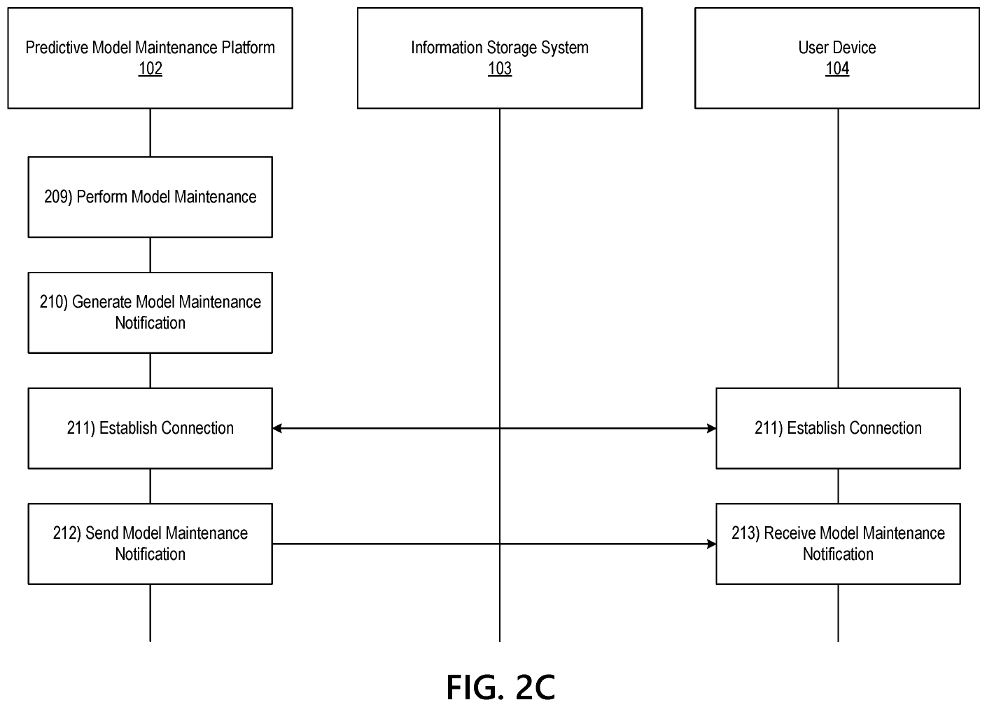

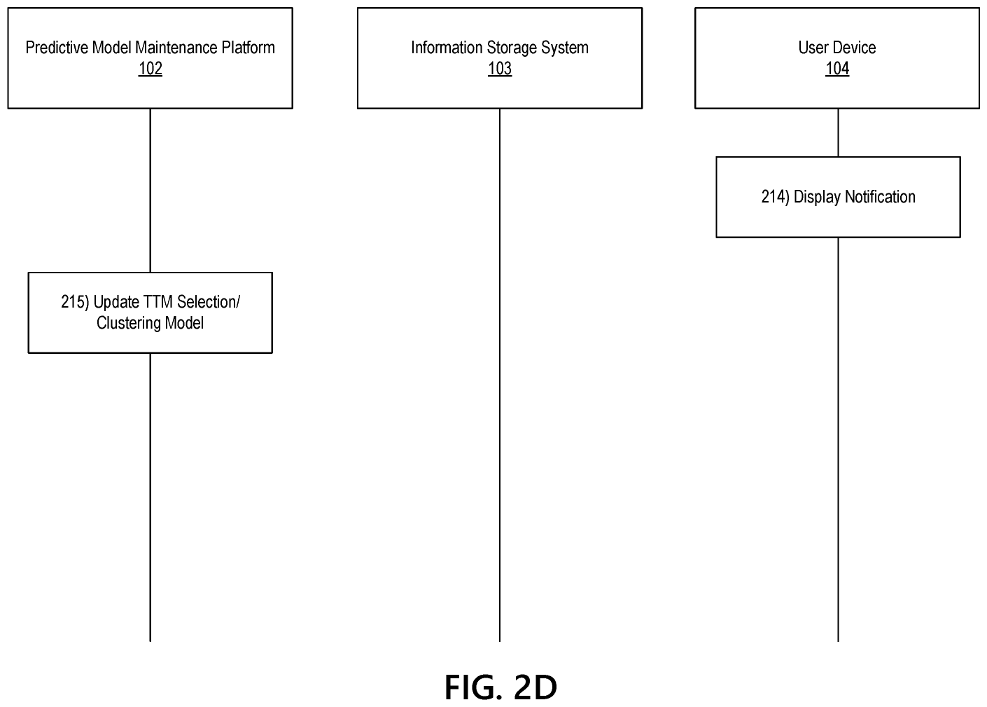

FIGS. 2A-2D depict an illustrative event sequence for using predictive maintenance for machine learning models in accordance with one or more example embodiments. Referring to FIG. 2A, at step 201, the predictive model maintenance platform 102 may train a machine learning model for TTM prediction. For example, the predictive model maintenance platform 102 may receive historical model performance information (e.g., model application domains, types of information used, number of model dimensions, number of model features, information ranges, information quality, data drift duration, concept drift duration, drift change derivatives, model classifier type. TTMs, and/or other information). In some instances, models may be labelled with this corresponding performance information, which may, e.g., train a machine learning model to cluster the corresponding models into clusters based on the similarity of their model performance information. The predictive model maintenance platform 102 may further train the TTM prediction model to generate, for each cluster of models, a predicted TTM (e.g., by taking an average of the TTMs of the models included in a given cluster, and/or otherwise). In doing so, the TTM prediction model may be trained to establish correlations between model clusters and corresponding TTMs, which may, e.g., cause the TTM prediction model to output, for a given cluster of models, a corresponding TTM.

In some instances, in training the machine learning model, predictive model maintenance platform 102 may use one or more supervised learning techniques (e.g., decision trees, bagging, boosting, random forest, k-NN, linear regression, artificial neural networks, support vector machines, and/or other supervised learning techniques), unsupervised learning techniques (e.g., classification, regression, clustering, anomaly detection, artificial neutral networks, and/or other unsupervised models/techniques), and/or other techniques. In some instances, the predictive model maintenance platform 102 may use a first machine learning technique to perform the model clustering and a second machine learning technique to perform the TTM prediction.

At step 202, the predictive model maintenance platform 102 may establish a connection with the information storage system 103. For example, the predictive model maintenance platform 102 may establish a first wireless data connection with the information storage system 103 to link the predictive model maintenance platform 102 with the information storage system 103 (e.g., in preparation for obtaining current model performance information). In some instances, the predictive model maintenance platform 102 may identify whether or not a connection is already established with the information storage system 103. For example, if the predictive model maintenance platform 102 identifies that a connection is already established with the information storage system 103, the predictive model maintenance platform 102 might not re-establish the connection. If the predictive model maintenance platform 102 identifies that a connection is not yet established with the information storage system 103, the predictive model maintenance platform 102 may establish the first wireless data connection as described herein.

At step 203, the predictive model maintenance platform 102 may obtain model performance information from the information storage system 103. For example, the predictive model maintenance platform 102 may obtain model application domains, types of information used, number of model dimensions, number of model features, information ranges, information quality, data drift duration, concept drift duration, drift change derivatives, model classifier type, TTMs, and/or other information for a plurality of models to be hosted and/or otherwise maintained by the predictive model maintenance platform 102. In these instances, the predictive model maintenance platform 102 may obtain the model performance information via the communication interface 113 and while the first wireless data connection is established.

At step 204, the predictive model maintenance platform 102 may cluster the plurality of models using the TTM prediction/clustering model. For example, the predictive model maintenance platform 102 may input the model performance information into the TTM prediction/clustering model, trained at step 201, which may, e.g., cause the TTM prediction/clustering model to group the plurality of machine learning models into a plurality of clusters based on similarities between the corresponding model performance information of the given models.

Referring to FIG. 2B, at step 205, the predictive model maintenance platform 102 may input information of the clusters, generated at step 204, into the TTM prediction/clustering model to produce TTMs for each respective cluster. For example, the predictive model maintenance platform 102 may aggregate (e.g., by identifying averages, standard deviations, medians, and/or other aggregate parameters) the model performance information for all machine learning models in a given cluster, and may compare this aggregated information to the historical model performance information used to train the TTM prediction/clustering model at step 201. Once a match (e.g., an exact match, approximate match, or the like) is identified, the TTM prediction/clustering model may identify a TTM corresponding to the matching model. In some instances, the TTM prediction/clustering model may further adjust the TTM based on a data drift duration, concept drift duration, drift change derivatives, and/or other information that may indicate a faster or slower rate of drift for the models of the given cluster. For example, the TTM prediction clustering model may adjust the TTM proportionally based on a comparison of the current drift value to the historical drift value (e.g., if drift is occurring at a rate 10% above the historical matching model, the TTM of that historical model may be reduced by 10% to trigger more frequent model maintenance to combat the drift, or the like).

At step 207, the predictive model maintenance platform 102 may store a correlation between the TTMs produced at step 206, the corresponding clusters, and the corresponding machine learning models. In doing so, the predictive model maintenance platform 102 may quickly reference the models associated with a given TTM and vice versa.

At step 208, the predictive model maintenance platform 102 may detect expiration of at least one TTM. For example, the predictive model maintenance platform 102 may dynamically monitor these TTMs for the various model clusters.

Referring to FIG. 2C, at step 209, based on or in response to detected expiration of the at least one TTM, the predictive model maintenance platform 102 may identify the corresponding model cluster (e.g., using the correlation stored at step 207) and may initiate model maintenance for all machine learning models in the corresponding cluster accordingly. For example, for each model in the identified cluster, the predictive model maintenance platform 102 may modify information used to train the model (e.g., using the model performance information received at step 203, or the like), the model dimensions, the model features, information ranges of the model, quality of the information used to train the model, and/or perform other model maintenance. In some instances, the predictive model maintenance platform 102 may automatically perform this maintenance without further user input. Additionally or alternatively, the predictive model maintenance platform 102 may notify a user of the expiration of the TTM, and may prompt a user to perform further maintenance accordingly (e.g., as is described below with regard to steps 210-214).

In some instances, in performing the model maintenance, the predictive model maintenance platform 102 may identify an updated TTM for the corresponding cluster. For example, the TTM prediction clustering model may adjust the TTM proportionally based on a comparison of the current drift value to the historical drift value (e.g., if drift is occurring at a rate 10% above the historical matching model, the TTM of that historical model may be reduced by 10% to trigger more frequent model maintenance to combat the drift, or the like). In some instances, the predictive model maintenance platform 102 may trigger an update to a TTM for the TTM prediction/clustering model itself. For example, the predictive model maintenance platform 102 may maintain a TTM for the TTM prediction/clustering model that is longer than the TTMs of the model clusters. Accordingly, if the predictive model maintenance platform 102 updates the TTM for a given cluster and the updated TTM for that cluster exceeds a current TTM of the TTM prediction/clustering model, the predictive model maintenance platform 102 may update the TTM of the TTM prediction/clustering model accordingly (e.g., to be longer than the updated TTM for the cluster). In some instances, upon detecting expiration of the TTM of the TTM prediction/clustering model, the predictive model maintenance platform 102 may automatically re-cluster the machine learning models previously clustered at step 204.

In some instances, in performing the model maintenance, the predictive model maintenance platform 102 may perform the maintenance for a plurality of models (e.g., in a given cluster) at substantially the same time. Furthermore, the maintenance may be performed on an as needed basis (e.g., based on the TTM), rather than performing maintenance at arbitrary intervals that may, in some instances, be too short (e.g., because maintenance might not yet be needed for the corresponding models). Similarly different TTMs may be assigned to different model clusters rather than applying the same TTM to all models or clusters. In some instances, the predictive model maintenance platform 102 may perform the maintenance before detecting, at any of the machine learning models in the corresponding cluster, that information drift exceeds an information drift threshold and/or concept drift that exceeds a concept drift threshold.

At step 210, the predictive model maintenance platform 102 may generate a model maintenance notification. For example, the predictive model maintenance platform 102 may generate a notification (based on or in response to the expiration of a given TTM) indicating that maintenance should be performed for the identified clusters, recommending maintenance to be performed, indicating that maintenance has already been performed, and/or other information.

At step 211, the predictive model maintenance platform 102 may establish a connection with the user device 104. For example, the predictive model maintenance platform 102 may establish a second wireless data connection with the user device 104 to link the predictive model maintenance platform 102 to the user device 104 (e.g., in preparation for sending model maintenance notifications). In some instances, the predictive model maintenance platform 102 may identify whether or not a connection is already established with the user device 104. If a connection is already established with the user device 104, the predictive model maintenance platform 102 might not re-establish the connection. Otherwise, if a connection is not yet established with the user device 104, the predictive model maintenance platform 102 may establish the second wireless data connection as described herein.

At step 212, the predictive model maintenance platform 102 may send the model maintenance notification (generated at step 210) to the user device 104. For example, the predictive model maintenance platform 102 may send the model maintenance notification to the user device 104 via the communication interface 113 and while the second wireless data connection is established. In some instances, the predictive model maintenance platform 102 may also send one or more commands directing the user device 104 to display the model maintenance notification.

At step 213, the user device 104 may receive the model maintenance notification sent at step 212. For example, the user device 104 may receive the model maintenance notification while the second wireless data connection is established. In some instances, the user device 104 may also receive the one or more commands directing the user device 104 to display the model maintenance notification.

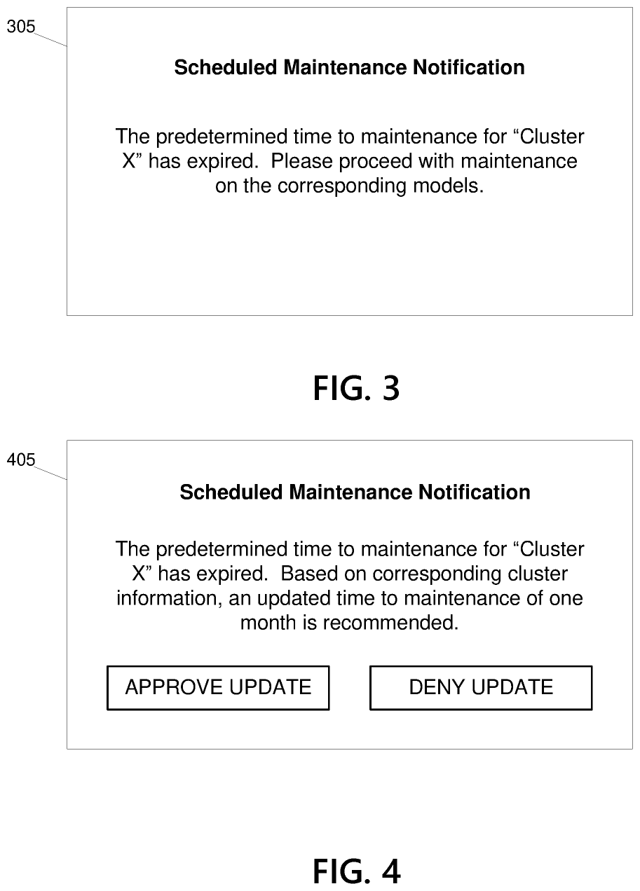

Referring to FIG. 2D, at step 214, based on or in response to the one or more commands directing the user device 104 to display the model maintenance notification, the user device 104 may display the model maintenance notification. For example, the user device 104 may display a graphical user interface similar to graphical user interface 305, which is illustrated in FIG. 3, and which indicates that the TTM has expired and that maintenance should be initiated by the user for the corresponding models. For example, to do so, the user device 104 may communicate with the predictive model maintenance platform 102 to perform such maintenance. Alternatively, the user device 104 may display a graphical user interface similar to graphical user interface 405, which is illustrated in FIG. 4, and which indicates that the TTM has expired and recommends a particular update of the TTM for the cluster (which may, e.g., be initiated upon acceptance of a corresponding interface element by the user).

At step 215, the predictive model maintenance platform 102 may update the TTM selection/clustering model based on the model performance information, the TTMs, the clustering information, maintenance performed, and/or other information. In doing so, the predictive model maintenance platform 102 may continue to refine the TTM selection/clustering model using a dynamic feedback loop, which may, e.g., increase the accuracy and effectiveness of the model in pre-emptively triggering model maintenance in a predictive and cluster specific manner. For example, the predictive model maintenance platform 102 may reinforce, modify, and/or otherwise update the TTM selection/clustering model, thus causing the model to continuously improve.

In some instances, the predictive model maintenance platform 102 may continuously refine the TTM selection/clustering model. In some instances, the predictive model maintenance platform 102 may maintain an accuracy threshold for the TTM selection/clustering model, and may pause refinement (through the dynamic feedback loops) of the model if the corresponding accuracy is identified as greater than the corresponding accuracy threshold. Similarly, if the accuracy fails to be equal or less than the given accuracy threshold, the predictive model maintenance platform 102 may resume refinement of the model through the corresponding dynamic feedback loop.

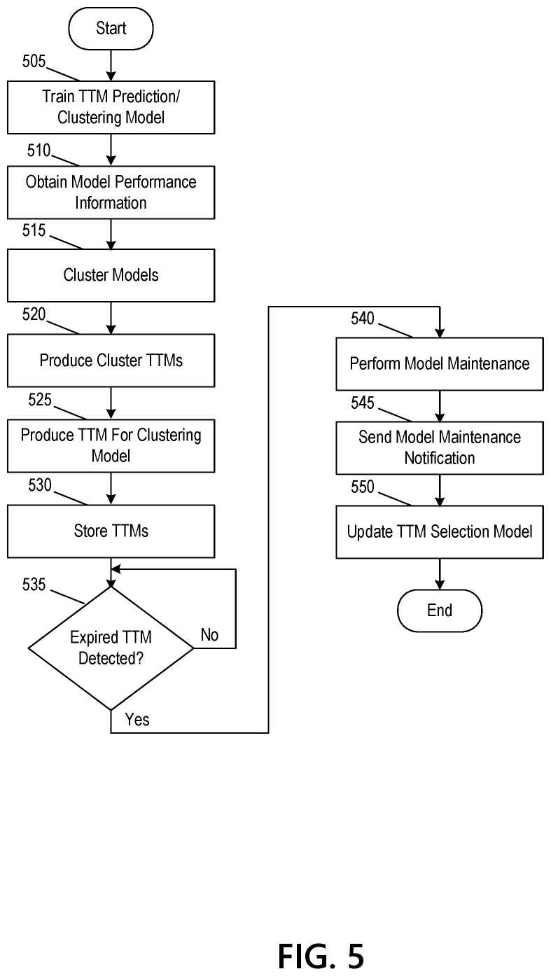

FIG. 5 depicts an illustrative method for using predictive maintenance for machine learning models in accordance with one or more example embodiments. Referring to FIG. 5, at step 505, a computing platform comprising one or more processors, memory, and a communication interface may train a TTM prediction/clustering model to cluster models based on their performance information, and assign TTMs to the corresponding clusters. At step 510, the computing platform may obtain model performance information. At step 515, the computing platform may cluster machine learning models, based on the model performance information. At step 520, the computing platform may input the model performance information for each model cluster into the TTM prediction/clustering model to produce cluster TTMs. At step 525, the computing platform may produce a TTM for the TTM prediction/clustering model itself. At step 530, the computing platform may store the TTMs. At step 535, the computing platform may identify whether any of the TTMs have expired. If not, the computing platform may wait until a TTM has expired. If any TTMs have expired, the computing platform may proceed to step 540.

At step 540, the computing platform may perform model maintenance for the models in the cluster corresponding to the expired TTM. At step 545, the computing platform may send a model maintenance notification to a user device. At step 550, the computing platform may update the TTM selection/clustering model.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
train, using historical model performance information, a time to maintenance (TTM) prediction model, wherein training the TTM prediction model configures the TTM prediction model to output, for a given cluster of machine learning models, a corresponding TTM;
obtain model performance information for a plurality of machine learning models;
cluster, using the model performance information, each of the plurality of machine learning models into one of a plurality of clusters of machine learning models;
for each cluster of the plurality of clusters:
identify, by inputting information of a corresponding cluster into the TTM prediction model, a TTM for the corresponding cluster,
store an association between the identified TTM for the corresponding cluster and machine learning models of the corresponding cluster;
detect, for a first cluster of the plurality of clusters, expiration of a first TTM corresponding to the first cluster; and
update, based on detection of the expiration of the first TTM, a first plurality of machine learning models included in the first cluster.

2. The computing platform of claim 1, wherein the historical model performance information comprises one or more of: model application domains, types of information used, number of model dimensions, number of model features, information ranges, information quality, data drift duration, concept drift duration, drift change derivatives, model classifier type, or TTMs.

3. The computing platform of claim 1, wherein the memory stores additional computer readable instructions that, when executed by the at least one processor, cause the computing platform to:
train, using the historical model performance information, a clustering model, wherein training the clustering model configures the clustering model to perform the clustering.

4. The computing platform of claim 3, wherein the clustering model has a second TTM, longer than the TTMs of the plurality of clusters.

5. The computing platform of claim 1, wherein updating a first machine learning model of the first plurality of machine learning models comprises updating one or more of: types of information used, number of model dimensions, number of model features, information ranges, information quality, or the first TTM.

6. The computing platform of claim 5, wherein updating the first TTM comprises automatically predicting, by the TTM prediction model, an updated TTM for the first cluster, wherein the prediction of the updated TTM is based on one or more of: data drift duration, concept drift duration, drift change derivatives for the first machine learning model.

7. The computing platform of claim 6, wherein the memory stores additional computer readable instructions that, when executed by the at least one processor, cause the computing platform to:
automatically update, based on detecting that the updated TTM for the first cluster exceeds a TTM of a clustering model, the TTM of the clustering model, wherein the updated TTM of the clustering model exceeds the updated TTM of the first cluster.

8. The computing platform of claim 7, wherein the memory stores additional computer readable instructions that, when executed by the at least one processor, cause the computing platform to:
automatically re-cluster, using the clustering model and based on detecting expiration of the TTM of the clustering model, the plurality of machine learning models.

9. The computing platform of claim 1, wherein updating the first plurality of machine learning models comprises updating each of the first plurality of machine learning models at substantially the same time.

10. The computing platform of claim 1, wherein updating the first plurality of machine learning models comprises updating each of the first plurality of machine learning models prior to detecting, in any of the first plurality of machine learning models, one or more of: information drift that exceeds an information drift threshold or concept drift that exceeds a concept drift threshold.

11. A method comprising:
at a computing platform comprising at least one processor, a communication interface, and memory:
training, using historical model performance information, a time to maintenance (TTM) prediction model, wherein training the TTM prediction model configures the TTM prediction model to output, for a given cluster of machine learning models, a corresponding TTM;
obtaining model performance information for a plurality of machine learning models;
clustering, using the model performance information, each of the plurality of machine learning models into one of a plurality of clusters of machine learning models;
for each cluster of the plurality of clusters:
identifying, by inputting information of a corresponding cluster into the TTM prediction model, a TTM for the corresponding cluster,
storing an association between the identified TTM for the corresponding cluster and machine learning models of the corresponding cluster;
detecting, for a first cluster of the plurality of clusters, expiration of a first TTM, corresponding to the first cluster; and
updating, based on detection of the expiration of the first TTM, a first plurality of machine learning models included in the first cluster.

12. The method of claim 11, wherein the historical model performance information comprises one or more of: model application domains, types of information used, number of model dimensions, number of model features, information ranges, information quality, data drift duration, concept drift duration, drift change derivatives, model classifier type, or TTMs.

13. The method of claim 11, wherein the memory stores additional computer readable instructions that, when executed by the at least one processor, cause the computing platform to:
train, using the historical model performance information, a clustering model, wherein training the clustering model configures the clustering model to perform the clustering.

14. The method of claim 13, wherein the clustering model has a second TTM, longer than the TTMs of the plurality of clusters.

15. The method of claim 11, wherein updating a first machine learning model of the first plurality of machine learning models comprises updating one or more of: types of information used, number of model dimensions, number of model features, information ranges, information quality, or the first TTM.

16. The method of claim 15, wherein updating the first TTM comprises automatically predicting, by the TTM prediction model, an updated TTM for the first cluster, wherein the prediction of the updated TTM is based on one or more of: data drift duration, concept drift duration, drift change derivatives for the first machine learning model.

17. The method of claim 16, further comprising:
automatically updating, based on detecting that the updated TTM for the first cluster exceeds a TTM of a clustering model, the TTM of the clustering model, wherein the updated TTM of the clustering model exceeds the updated TTM of the first cluster.

18. The method of claim 17, further comprising:
automatically re-clustering, using the clustering model and based on detecting expiration of the TTM of the clustering model, the plurality of machine learning models.

19. The method of claim 11, wherein updating the first plurality of machine learning models comprises updating each of the first plurality of machine learning models at substantially the same time.

20. One or more non-transitory computer-readable media storing instructions that, when executed by a computing platform comprising at least one processor, a communication interface, and memory, cause the computing platform to:
train, using historical model performance information, a time to maintenance (TTM) prediction model, wherein training the TTM prediction model configures the TTM prediction model to output, for a given cluster of machine learning models, a corresponding TTM;
obtain model performance information for a plurality of machine learning models;
cluster, using the model performance information, each of the plurality of machine learning models into one of a plurality of clusters of machine learning models;
for each cluster of the plurality of clusters:
identify, by inputting information of a corresponding cluster into the TTM prediction model, a TTM for the corresponding cluster,
store an association between the identified TTM for the corresponding cluster and machine learning models of the corresponding cluster;
detect, for a first cluster of the plurality of clusters, expiration of a first TTM, corresponding to the first cluster; and
update, based on detection of the expiration of the first TTM, a first plurality of machine learning models included in the first cluster.
